(19) United States
(12) Patent Application Publication
(10) Pub. No.: US 2022/0344730 A1
(43) Pub. Date: Oct. 27, 2022

(54) CONDUCTIVE MODULE AND CONDUCTIVE SYSTEM

(71) Applicant: Yazaki Corporation, Tokyo (JP)

(72) Inventors: Tatsuya Oga, Shizuoka (JP); Hirotaka Mukasa, Shizuoka (JP); Yuta Fukuchi, Shizuoka (JP); Yoshiaki Ichikawa, Shizuoka (JP)

(21) Appl. No.: 17/720,314

(22) Filed: Apr. 14, 2022

(30) Foreign Application Priority Data
Apr. 27, 2021 (JP) 2021-074528

(51) Int. Cl. H01M 10/42; H01M 50/507; H01M 50/204; B60L 58/10

(52) U.S. Cl. CPC H01M 10/425; H01M 50/507; H01M 50/204; B60L 58/10; H01M 2220/20

(57) ABSTRACT

A conductive module includes a conductive part is provided with a flat laminated body formed of a plurality of conductors and an insulator having flexibility. The conductive part includes a first conductor that is configured to electrically connect the battery cells to a battery monitoring unit, and a second conductor that is configured to electrically connect the battery monitoring unit to electrical equipment, as the conductors, and includes a first connector that is configured to be fitted and connected to a counterpart connector of the battery monitoring unit and is configured to electrically connect the first conductor and the second conductor to the battery monitoring unit, and a second connector that is configured to be fitted and connected to a counterpart connector disposed on the electrical connection box side and is configured to electrically connect the second conductor to the electrical equipment.

### CROSS-REFERENCE TO RELATED APPLICATION(S)

The present application claims priority to and incorporates by reference the entire contents of Japanese Patent Application No. 2021-074528 filed in Japan on Apr. 27, 2021.

### BACKGROUND OF THE INVENTION

### Field of the Invention

The present invention relates to a conductive module and a conductive system.

### 2. Description of the Related Art

Conventionally, in a vehicle (an electric vehicle, a hybrid vehicle, or the like) that uses a rotating machine as a driving source, a battery pack including a battery module that supplies power to the rotating machine, and a conductive module electrically connected to a plurality of battery cells that form the battery module is mounted. For example, the conductive module causes a battery monitoring unit to monitor the battery status of the battery cells, by electrically connecting the battery cells and the battery monitoring unit. For example, Japanese Patent Application Laid-open No. 2018-26311 discloses such a conductive module that uses a conductive part (flexible printed circuit board and the like) provided with a flat laminated body formed of a plurality of conductors and an insulator.

In recent years, to improve the electricity consumption and to extend the cruising range of vehicles, an improvement in the energy density of a battery pack is sought after. Thus, in the battery pack, an increase in the size of the battery pack due to an increase in the energy density of battery cells has become a matter of concern, and a reduction in the size of the battery pack is also sought after to improve the mountability to a vehicle. A reduction in the size of the conductive module is also sought after without exception.

### SUMMARY OF THE INVENTION

Thus, an object of the present invention is to provide a conductive module and a conductive system capable of reducing the size.

In order to solve the above mentioned problem and achieve the object, a conductive module according to one aspect of the present invention includes a conductive part that is a part to be mounted on a battery module in which a plurality of battery cells are arranged in an arrangement direction, and is provided with a flat laminated body formed of a plurality of conductors and an insulator having flexibility, wherein the conductive part includes a first conductor that is configured to electrically connect the battery cells to a battery monitoring unit for monitoring a battery status of the battery cells, and a second conductor that is configured to electrically connect the battery monitoring unit to electrical equipment housed in an external electrical connection box, as the conductors, and includes a first connector that is fitted and connected to a counterpart connector of the battery monitoring unit and that is configured to electrically connect the first conductor and the second conductor to the battery monitoring unit, and a second connector that is configured to be fitted and connected to a counterpart connector disposed on the electrical connection box side and is configured to electrically connect the second conductor to the electrical equipment.

In order to achieve the object, a conductive module according to another aspect of the present invention includes a conductive part that is a part to be mounted on each battery module in which a plurality of battery cells are arranged in an arrangement direction, and is provided with a flat laminated body formed of a plurality of conductors and an insulator having flexibility, wherein the conductive part includes a first conductor that is configured to electrically connect the battery cells to a battery monitoring unit for monitoring a battery status of the battery cells as one of the conductors, and includes a first connector that is configured to be fitted and connected to a counterpart connector of the battery monitoring unit and is configured to electrically connect the first conductor to the battery monitoring unit, and one of a plurality of the conductive parts further includes a second conductor that is configured to electrically connect the battery monitoring unit to electrical equipment housed in an external electrical connection box as one of the conductors, includes a second connector that is configured to be fitted and connected to a counterpart connector disposed on the electrical connection box side and is configured to electrically connect the second conductor to the electrical equipment, and is configured to electrically connect the second conductor to the battery monitoring unit via the first connector provided in the conductive part.

According to still another aspect of the present invention, in the conductive module, is preferable that the conductive module includes a conductor member that is a connection part configured to electrically connect a plurality of electrode terminals of the battery cells adjacent to each other in the arrangement direction, and that is provided for each combination of two adjacent electrode terminals arranged in the arrangement direction, wherein the first conductor is provided for each conductor member.

According to still another aspect of the present invention, in the conductive module, it is preferable that the laminated body is a flexible printed circuit board.

In order to achieve the object, a conductive system according to still another aspect of the present invention includes a conductive module; an electrical connection box in which electrical equipment is housed; and an electrical connection tool that electrically connects the conductive module and the electrical equipment, wherein the conductive module includes a conductive part that is a part to be mounted on a battery module in which a plurality of battery cells are arranged in an arrangement direction, and is provided with a flat laminated body formed of a plurality of conductors and an insulator having flexibility, and the conductive part includes a first conductor that is configured to electrically connect the battery cells to a battery monitoring unit for monitoring a battery status of the battery cells, and a second conductor that is configured to electrically connect the battery monitoring unit to the electrical equipment via the electrical connection tool, as the conductors, and includes a first connector that is configured to be fitted and connected to a counterpart connector of the battery monitoring unit and is configured to electrically connect the first conductor and the second conductor to the battery monitoring unit, and a second connector that is configured to be fitted and connected to a counterpart connector of the electrical connection tool and is configured to electrically connect the second conductor to the electrical equipment.

In order to achieve the object, a conductive system according to still another aspect of the present invention includes a conductive module; an electrical connection box in which electrical equipment is housed; and an electrical connection tool that electrically connects the conductive module and the electrical equipment, wherein the conductive module includes a conductive part that is a part to be mounted on each battery module in which a plurality of battery cells are arranged in an arrangement direction, and is provided with a flat laminated body formed of a plurality of conductors and an insulator having flexibility, the conductive part includes a first conductor that is configured to electrically connect the battery cells to a battery monitoring unit for monitoring a battery status of the battery cells as one of the conductors, and includes a first connector that is configured to be fitted and connected to a counterpart connector of the battery monitoring unit and is configured to electrically connect the first conductor to the battery monitoring unit, and one of a plurality of the conductive parts further includes a second conductor that is configured to electrically connect the battery monitoring unit to the electrical equipment via the electrical connection tool as one of the conductors, includes a second connector that is configured to be fitted and connected to a counterpart connector of the electrical connection tool and is configured to electrically connect the second conductor to the electrical equipment, and electrically connect the second conductor to the battery monitoring unit via the first connector provided in the conductive part.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a plan view illustrating a conductive module and a conductive system of an embodiment;

FIG. 2 is a partially enlarged plan view of a first conductive part and the surrounding components;

FIG. 3 is a partially enlarged plan view of a second conductive part and the surrounding components;

FIG. 4 is a perspective view illustrating a battery pack of the embodiment; and

FIG. 5 is a perspective view illustrating the conductive module of the embodiment.

### DETAILED DESCRIPTION OF THE PREFERRED EMBODIMENTS

Hereinafter, an embodiment of a conductive module and a conductive system according to the present invention will be described in detail with reference to the accompanying drawings. However, the invention is not limited to the embodiment.

### Embodiment

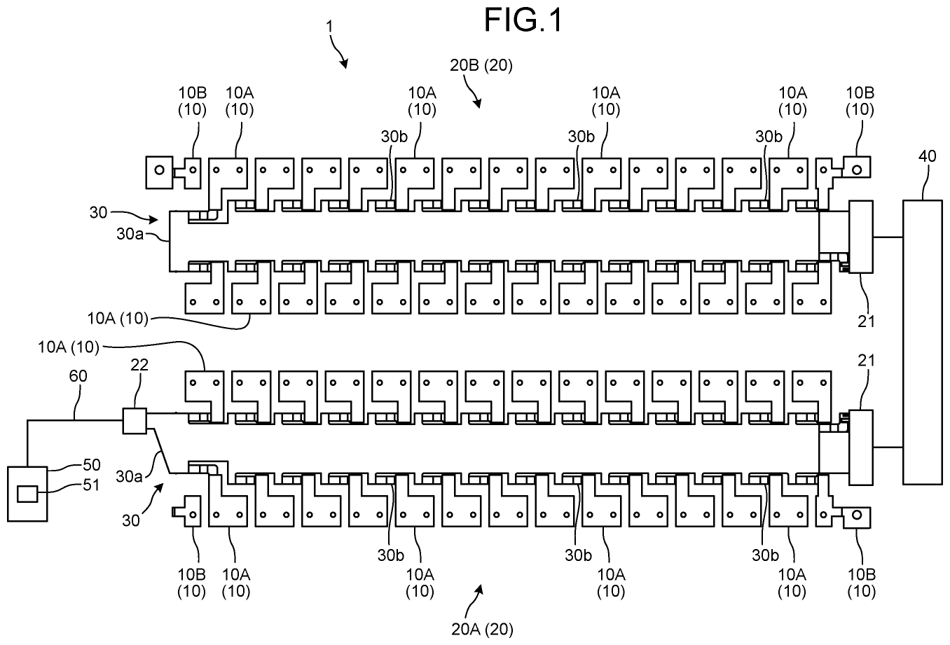

One of the embodiments of the conductive module and the conductive system according to the present invention will be described with reference to FIG. 1 to FIG. 5.

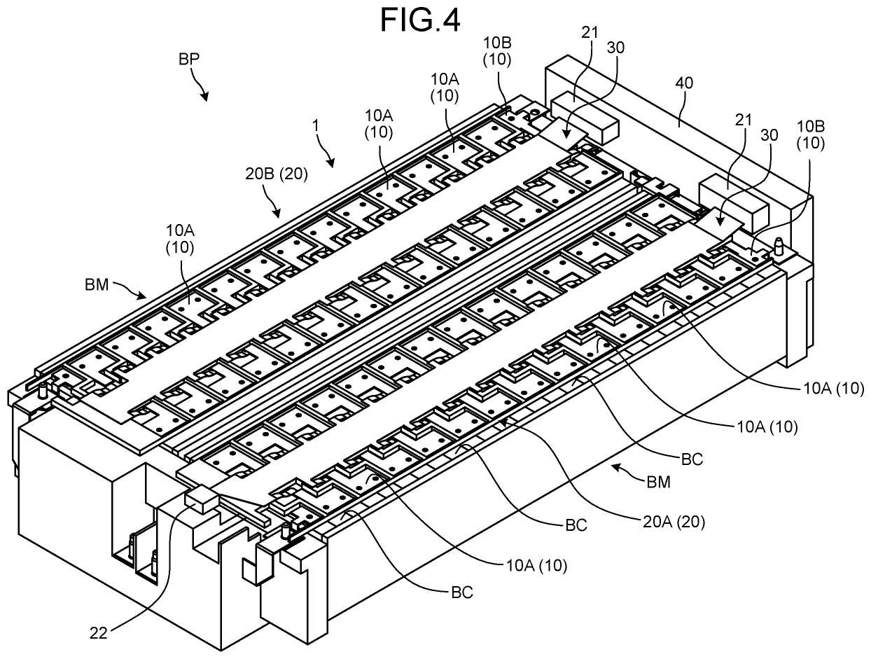

The reference numeral 1 in FIG. 1 to FIG. 4 indicates a conductive module in the present embodiment. A conductive module 1 is assembled to a battery module BM to form a battery pack BP with the battery module BM (FIG. 4). The battery pack BP is to be mounted on a vehicle (an electric vehicle, a hybrid vehicle, or the like) including a rotating machine as a driving source, and is used to supply power to the rotating machine and the like.

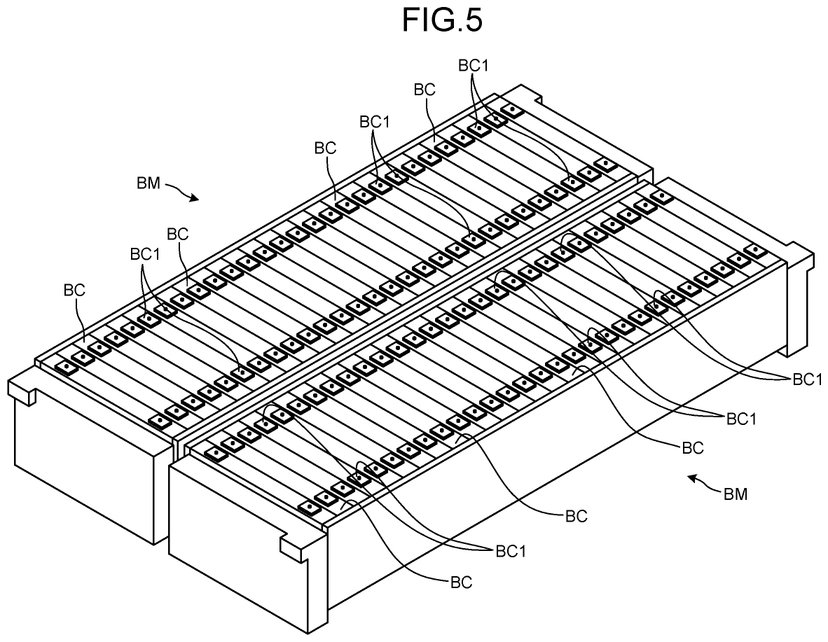

The battery module BM includes a plurality of battery cells BC arranged in an arrangement direction (FIG. 4 and FIG. 5). Each of the battery cells BC has two electrode terminals BC1 (FIG. 5). Each of the electrode terminals BC1 is disposed in a state of being exposed to the outside, with one of the electrode terminals BC1 serving as a positive electrode and the other electrode terminal BC1 serving as a negative electrode. In the battery cell BC illustrated in this example, the housing is formed in a cuboid shape, and on one of six outer wall surfaces of the housing, each electrode terminal BC1 is arranged at intervals in an orthogonal direction with respect to the arrangement direction of each battery cell BC. Moreover, each electrode terminal BC1 illustrated in this example is formed in a plate shape having a plane surface parallel to the outer wall surface of the housing. A terminal connection part 10 serving as a conductor member, which will be described below, is physically and electrically connected to one of the plane surfaces.

The battery cells BC are arranged side by side in one direction, with one of the electrode terminals BC1 and the other electrode terminal BC1 arranged side by side in a line. Thus, in the battery module BM, there are two electrode terminal groups including the electrode terminals BC1 arranged side by side in a line (FIG. 1 and FIG. 6). In the following, unless otherwise specified, the term “arrangement direction” refers to the arrangement direction of the battery cells BC and the arrangement direction of the electrode terminals BC1 in each electrode terminal group.

In the battery module BM, for each electrode terminal group, the battery cells BC are connected in series or parallel, when the electrode terminals BC1 are electrically connected in a predetermined combination by a terminal connection part. In the battery module BM illustrated in this example, in each electrode terminal group, the electrode terminals BC1 that are adjacent to each other in the arrangement direction are electrically connected by the terminal connection part 10, which will be described below. Moreover, in the battery module BM illustrated in this example, there are two electrode terminals BC1 that are not connected by the terminal connection part 10, and one of such electrode terminals BC1 is a total positive electrode, and the other electrode terminal BC1 is a total negative electrode.

The battery pack BP includes at least one battery module BM. The conductive module is assembled to the battery module BM provided in the battery pack BP, and is electrically connected to each of the battery cells BC of the battery module BM. The battery pack B illustrated in this example includes two battery modules BM. Then, the two battery modules BM are arranged side by side in the arrangement direction of the positive and negative electrode terminals BC1 of the battery cells BC.

Therefore, the conductive module 1 illustrated in this example is assembled to the two battery modules BM, and electrically connected to each of the battery cells BC of each of the battery modules BM.

First, the conductive module 1 includes the conductor member (hereinafter referred to as the “terminal connection part”) 10 to be electrically connected to the electrode terminal BC1 of each battery cell BC (FIG. 1 to FIG. 4). Furthermore, the conductive module 1 includes a conductive part 20 to be mounted on the battery module BM (FIG. 1 to FIG. 4). In the case where the battery pack BP includes a plurality of the battery modules BM, the conductive module 1 includes a plurality of the terminal connection parts 10 corresponding to the battery cells BC of all the battery modules BIM, and includes the conductive part 20 for each of the battery modules BM.

As the terminal connection part 10, the conductive module 1 includes a first terminal connection part 10A that is a connection part configured to electrically connect the electrode terminals BC1 of the battery cells BC adjacent to each other in the arrangement direction, and that is provided for each combination of two adjacent electrode terminals BC arranged in the arrangement direction (FIG. 1 to FIG. 4). Furthermore, as the terminal connection part 10, the conductive module 1 includes a second terminal connection part 10B for the total electrode (FIG. 1 to FIG. 4). There are two types of the second terminal connection part 10B: one that is to be electrically connected to the electrode terminal BC1 serving as the total positive electrode, and one that is to be electrically connected to the electrode terminal BC1 serving as the total negative electrode.

The terminal connection part 10 (10A, 10B) is formed of a conductive material such as metal. The terminal connection part 10 is what is called a bus bar formed of a metal plate as a base material, and the main body is formed in a substantially rectangular flat plate shape. The terminal connection part 10 illustrated in this example is welded (laser welded or the like) to one of the plane surfaces of the electrode terminal BC1, and thus the terminal connection part 10 is physically and electrically connected to the electrode terminal BC1. For example, the first terminal connection part 10A is welded to each of the electrode terminals BC1 adjacent to each other in the arrangement direction. On the other hand, the second terminal connection part 10B is welded to one electrode terminal BC1 to be connected.

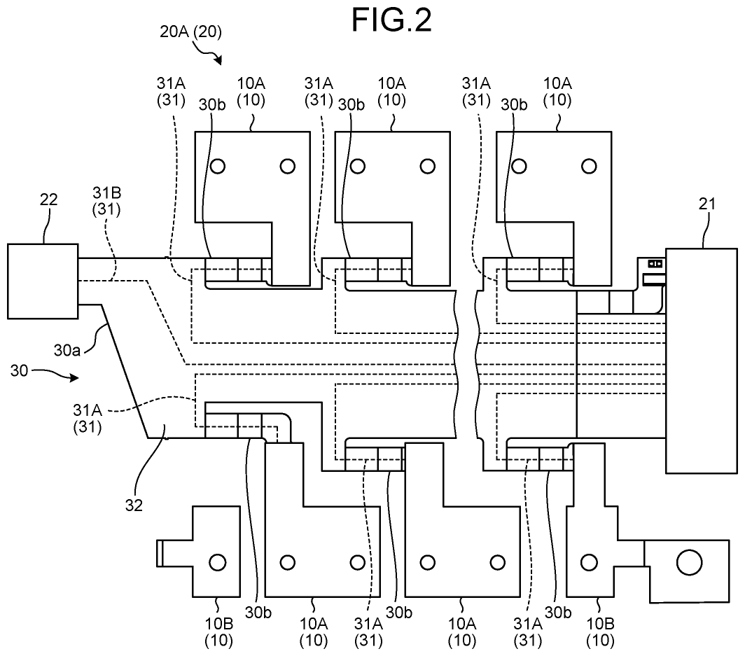

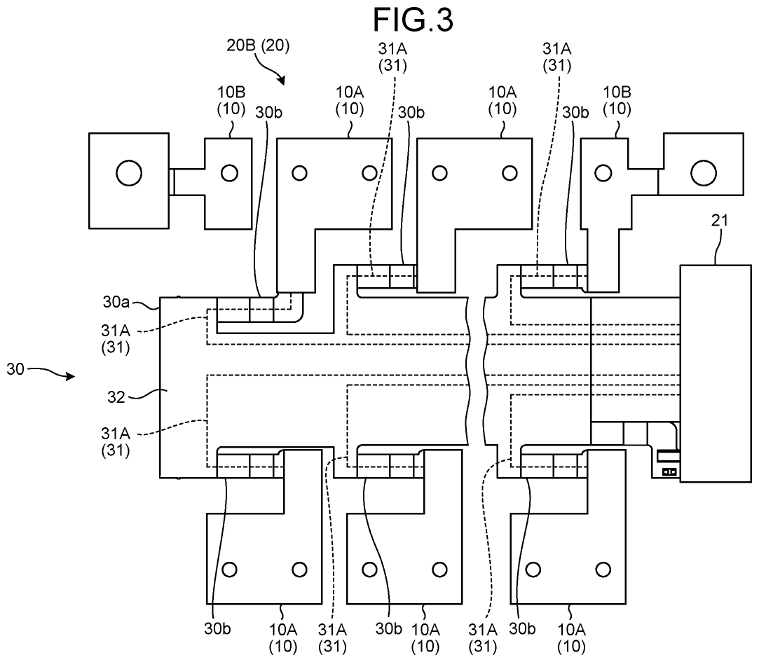

The conductive part 20 includes a flat laminated body 30 formed of a plurality of conductors 31 and an insulator 32 having flexibility (FIG. 2 and FIG. 3). In the laminated body 30, a circuit pattern is formed by the conductors 31, and the conductors 31 are covered by the insulator 32. Any type of laminated body 30 may be used as long as the laminated body 30 has such a configuration. The laminated body 30 illustrated in this example is a flexible printed circuit board (what is called an FPC).

The laminated body 30 has a main body 30a formed in a rectangular sheet shape, and a branch body 30b branched from the main body 30a (FIG. 1 to FIG. 3). The main body 30a is formed in a rectangular shape in which the side parts at both ends in the arrangement direction are short sides, and the side parts at both ends in the orthogonal direction with respect to the arrangement direction are long sides. In the main body 30a, the conductors 31 (a first conductor 31A and a second conductor 31B, which will be described below) are covered by the insulator 32. On the other hand, the branch body 30b is provided for each first conductor 31A, which will be described below. The branch body 30b is branched from each of the long sides of the main body 30a. In the branch body 30b, the first conductor 31A is covered by the insulator 32, and a part of the first conductor 31A is exposed from the insulator 32.

As the conductor 31, the laminated body 30 includes the first conductor 31A that is configured to electrically connect the battery cells BC to a battery monitoring unit 40 (FIG. 1 and FIG. 4).

The battery monitoring unit 40 is a device for monitoring the battery status (voltage, current, temperature, and the like) of the battery cells BC. For example, in the case where the battery pack BP includes the battery modules BM, the battery monitoring unit 40 monitors the battery status of each battery cell BC of all the battery modules BM. The battery monitoring unit 40 illustrated in this example monitor the battery status of each battery cell BC of the two battery modules BM. Then, the battery monitoring unit 40 illustrated in this example is assembled to the side wall of the battery module group formed of the two battery modules BM. In this example, in the battery module group, the battery monitoring unit 40 is assembled to one of the side walls in the arrangement direction of the battery cells BC.

For example, the first conductor 31A is provided for each terminal connection part 10 in the conductive part 20. Each of a plurality of the first conductors 31A is formed from the main body 30a to the branch body 30b for each terminal connection cart 10. Then, the first conductor 31A is physically and electrically connected to the terminal connection part 10. For example, the first conductor 31A is physically and electrical connected to the terminal connection part 10, by soldering the exposed portion of the branch body 30b to the terminal connection part 10.

The conductive part 20 includes a first connector 21 that is configured to electrically connect the first conductor 31A to the battery monitoring unit 40 (FIG. 1 to FIG. 4). The first connector 21 is assembled to the side part of the main body 30a of the laminated body 30. In the main body 30a, the first connector 21 illustrated in this example is assembled to the side part, which is one of the short sides at the side where the battery monitoring unit 40 is disposed. Moreover, the first connector 21 is fitted and connected to a counterpart connector (not illustrated) of the battery monitoring unit 40. This first connector 21 includes a terminal metal fitting (not illustrated) for each first conductor 31A of the laminated body 30, and the terminal, metal fitting is fitted and connected to a counterpart terminal metal fitting for the first conductor 31A (not illustrated) of the counterpart connector. The battery monitor unit 40 illustrated in this example includes a counterpart connector for each conductive part 20.

In this example, in the case where the battery pack BP includes only one battery module BM, the conductive module 1 includes only one conductive part 20 corresponding to the battery module BM. In this case, as the conductor 31, the laminated body 30 includes the second conductor 31B that is configured to electrically connect the battery monitoring unit 40 to electrical equipment 51 (FIG. 1) housed in an external electrical connection box 50.

For example, the electrical connection box 50 houses various types of electrical equipment 51 such as an electronic control device that controls braking and driving force of a vehicle or the like, and an electrical connection member such as a bus bar (not illustrated). Then, for example, the electrical connection box 50 is fixed to the body of a vehicle or the like. For example, the electrical equipment 51 serving as an electronic control device controls the driving force of a rotating machine of the vehicle, based on a detection signal of the battery status of the battery cells BC transmitted from the battery monitoring unit 40 via the second conductor 31B.

The second conductor 31B is formed from the side part, which is one of the short sides of the main body 30a, to the side part, which is the other short side of the main body 30a. For example, in this case, the laminated body 30 includes a circuit pattern layer having all the first conductors 31A, a circuit pattern layer having the second conductor 31B, an insulator layer between the two circuit pattern layers, and two insulator layers sandwiching these three layers from each circuit pattern layer side.

The second conductor 31B is electrically connected to the battery monitoring unit 40 via the first connector 21. Therefore, the first connector 21 also includes a terminal metal fitting for the second conductor 31B (not illustrated), and the terminal metal fitting is fitted and connected to a counterpart terminal metal fitting for the second conductor 31B (not illustrated) in the counterpart connector of the battery monitoring unit 40.

Furthermore, in this case, the conductive part 20 includes a second connector 22 that is configured to electrically connect the second conductor 31B to the electrical equipment 51 (FIG. 1, FIG. 2, and FIG. 4). This second connector 22 is assembled to the side part of the main body 30a of the laminated body 30. In the main body 30a, the second connector 22 illustrated in this example is assembled to the side part, which is the other short side opposite to the side where the battery monitoring unit 40 is disposed. Moreover, the second connector 22 is fitted and connected to the counterpart connector (not illustrated) disposed on the electrical connection box 50 side. The second connector 22 includes a terminal metal fitting for the second conductor 31B (not illustrated), and the terminal metal fitting is fitted and connected to the counterpart terminal metal fitting for the second conductor 31B (not illustrated) in the counterpart connector on the electrical connection box 50 side.

For example, between the conductive module 1 and the electrical equipment 51, there is an electrical connection tool 60 configured to electrically connect the conductive module 1 and the electrical equipment 51 (FIG. 1). For example, although not illustrated, the electrical connection tool 60 includes an electric wire and connectors fixed to both ends of the electric wire, and one of the connectors is used as a counterpart connector on the electrical connection box 50 side, and the other connector is fitted and connected to the connector (not illustrated) of the electrical equipment 51. Consequently, the second conductor 31B is electrically connected to the electrical equipment 51.

In the case where a single battery module BM as described above is provided, the conductive module 1, the electrical connection box 50, and the electrical connection tool 60 form a conductive system that detects the battery status information of the battery cells BC of the single battery module BM and that transmits the battery status information to the electrical equipment 51. The conductive system may also include the battery monitoring unit 40 as a component of the system.

Subsequently, in the case where the battery pack BP includes a plurality of the battery modules BM, as described above, the conductive module 1 includes the conductive part 20 for each of the battery modules BM.

In this case, one of a plurality of the conductive parts 20 (hereinafter referred to as a “first conductive part 20A”) is configured the same as the conductive part 20 that includes the second conductor 31B and the second connector 22 as in the above-described example (FIG. 1 and FIG. 2). In other words, the first conductive part 20A includes the first conductor 31A for each terminal connection part 10 corresponding to the battery cell BC of the battery module BM to which the first conductive part 20A is assembled, the second conductor 31B that is configured to electrically connect the battery monitoring unit 40 to the electrical equipment 51 of the electrical connection box 50, the first connector 21 that electrically connects all the first conductors 31A and the second conductor 31B to the battery monitoring unit 40, and the second connector 22 that is configured to electrically connect the second conductor 31B to the electrical equipment 51 via the electrical connection tool 60.

On the other hand, the remaining of the conductive parts 20 (hereinafter referred to as a “second conductive part 20B”) includes the first conductor 31A for each terminal connection part 10 corresponding to the battery cell BC of the battery module BM to which the second conductive part 20B is assembled, and the first connector 21 that is configured to electrically connect all the first conductors 31A to the battery monitoring unit 40 (FIG. 1 and FIG. 3).

In the case where a plurality of the battery modules BM as described above are provided, the conductive module 1, the electrical connection box 50, and the electrical connection tool 60 form a conductive system that detects the battery status information of the battery cells BC of the battery modules BM and that transmits the battery status information to the electrical equipment 51. The conductive system may also include the battery monitoring unit 40 as a component of the system.

As described above, in the conductive module 1 and the conductive system of the present embodiment, not only the first conductor 31A that is configured to electrically connect the battery cells BC and the battery monitoring unit 40, but also the second conductor 31B that is configured to electrically connect the battery monitoring unit 40 to the electrical equipment 51 of the electrical connection box 50 is provided as the conductor 31 of the conductive part 20 (first conductive part 20A). Then, in the conductive module 1 and the conductive system, the first conductor 31A and the second conductor 31B are electrically connected to the counterpart connector of the battery monitoring unit 40 via the first connector 21, and the second conductor 31B is electrically connected to the counterpart connector on the electrical connection box 50 side via the second connector 22. Thus, the conductive module 1 and the conductive system do not need to arrange a conductor such as an electric wire that is configured to electrically connect the battery monitoring unit 40 and the electrical equipment 51 of the electrical connection box 50 on a path different from that of the conductive part 20. Consequently, it is possible to reduce the size. Furthermore, because the conductive module 1 and the conductive system do not require a connector dedicated to the conductor, there is no need to prepare a counterpart connector in the battery monitoring unit 40 to fit and connect the connector. Consequently, it is also possible to reduce the size of the battery monitoring unit 40. Thus, the conductive module 1 and the conductive system of the present embodiment can reduce the size of the battery pack BP, by reducing the size of the conductive module 1 and the conductive system, and reducing the size of the battery monitoring unit 40. Consequently, it is possible to improve the mountability of the battery pack IBP to a vehicle.

In the conductive module and the conductive system according to the present embodiment, not only the first conductor that is configured to electrically connect the battery cells and the battery monitoring unit, but also the second conductor that is configured to electrically connect the battery monitoring unit to the electrical equipment of the electrical connection box is provided as the conductor of the conductive part (first conductive cart). Then, in the conductive module and the conductive, system, the first conductor and the second conductor are electrically connected to the counterpart connector of the battery monitoring unit via the first connector, and the second conductor is electrically connected to the counterpart connector on the electrical connection box side via the second connector. Thus, the conductive module and the conductive system do not need to arrange a conductor such as an electric wire that is configured to electrically connect the battery monitoring unit and the electrical equipment of the electrical connection box on a path different from that of the conductive part. Consequently, it is possible to reduce the size. Furthermore, because the conductive module and the conductive system do not require a connector dedicated to the conductor, there is no need to prepare a counterpart connector in the battery monitoring unit to fit and connect the connector.

Consequently, it is also possible to reduce the size of the battery monitoring unit. Thus, the conductive module and the conductive system according to the present embodiment can reduce the size of the battery pack, by reducing the size of the conductive module and the conductive system, and reducing the size of the battery monitoring unit. Consequently, it is possible to improve the mountability of the battery pack to a vehicle.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A conductive module, comprising:
a conductive part that is a part to be mounted on a battery module in which a plurality of battery cells are arranged in an arrangement direction, and is provided with a flat laminated body formed of a plurality of conductors and an insulator having flexibility, wherein
the conductive part includes a first conductor that is configured to electrically connect the battery cells to a battery monitoring unit for monitoring a battery status of the battery cells, and a second conductor that is configured to electrically connect the battery monitoring unit to electrical equipment housed in an external electrical connection box, as the conductors, and includes a first connector that is fitted and connected to a counterpart connector of the battery monitoring unit and that is configured to electrically connect the first conductor and the second conductor to the battery monitoring unit, and a second connector that is configured to be fitted and connected to a counterpart connector disposed on the electrical connection box side and is configured to electrically connect the second conductor to the electrical equipment.

2. A conductive module, comprising:
a conductive part that is a part to be mounted on each battery module in which a plurality of battery cells are arranged in an arrangement direction, and is provided with a flat laminated body formed of a plurality of conductors and an insulator having flexibility, wherein
the conductive part includes a first conductor that is configured to electrically connect the battery cells to a battery monitoring unit for monitoring a battery status of the battery cells as one of the conductors, and includes a first connector that is configured to be fitted and connected to a counterpart connector of the battery monitoring unit and is configured to electrically connect the first conductor to the battery monitoring unit, and
one of a plurality of the conductive parts further includes a second conductor that is configured to electrically connect the battery monitoring unit to electrical equipment housed in an external electrical connection box as one of the conductors, includes a second connector that is configured to be fitted and connected to a counterpart connector disposed on the electrical connection box side and is configured to electrically connect the second conductor to the electrical equipment, and is configured to electrically connect the second conductor to the battery monitoring unit via the first connector provided in the conductive part.

3. The conductive module according to claim 1, further comprising:
a conductor member that is a connection part configured to electrically connect a plurality of electrode terminals of the battery cells adjacent to each other in the arrangement direction, and that is provided for each combination of two adjacent electrode terminals arranged in the arrangement direction, wherein
the first conductor is provided for each conductor member.

4. The conductive module according to claim 2, further comprising:
a conductor member that is a connection part configured to electrically connect a plurality of electrode terminals of the battery cells adjacent to each other in the arrangement direction, and that is provided for each combination of two adjacent electrode terminals arranged in the arrangement direction, wherein
the first conductor is provided for each conductor member.

5. The conductive module according to claim 1, wherein
the laminated body is a flexible printed circuit board.

6. The conductive module according to claim 2, wherein
the laminated body is a flexible printed circuit board.

7. The conductive module according to claim 3, wherein
the laminated body is a flexible printed circuit board.

8. A conductive system, comprising:
the conducive module according to claim 1;
an electrical connection box in which electrical equipment is housed; and
an electrical connection tool that electrically connects the conductive module and the electrical equipment.

9. A conductive system, comprising:
the conductive module according to claim 2;
an electrical connection box in which electrical equipment is housed; and
an electrical connection tool that electrically connects the conductive module and the electrical equipment.
